(19) United States
(12) Patent Application Publication
(10) Pub. No.: US 2005/0121481 A1
(43) Pub. Date: Jun. 9, 2005

(54) Walker basket

(76) Inventor: Johnny J.T. Chiu, Hsichih City (TW)

Correspondence Address: DAVID A. HALL, HELLER EHRMAN ET AL., 4350 LA JOLLA VILLAGE DRIVE #700, SAN DIEGO, CA, 92122, US

(21) Appl. No.: 10/946,996

(22) Filed: Sep. 22, 2004

Related U.S. Application Data
(60) Provisional application No. 60/505,039, filed on Sep. 22, 2003.

(51) Int. Cl. B60R 7/00; B60R 9/00; B60R 1/00

(52) U.S. Cl. 224/407

(57) ABSTRACT

A basket that can be attached to a walking aid and that can store a large number of items but does not consume a large amount of space when not in use. The basket can be configured to be removably coupled to the walking aid. The basket includes a frame having sides and ends that are scissor hinges. The scissor hinges operate such that the frame sides can be position next to each other in a collapsed state and separated from each other in an expanded state so as to form an internal cavity to carry items. A flexible material is attached to the frame sides and scissor hinges thereby forming side walls and a bottom.

### REFERENCE TO PRIORITY APPLICATION

This application claims the benefit of priority of co-pending U.S. Provisional Patent Application Ser. No. 60/505,039 entitled “Walker Basket”, filed Sep. 22, 2003, the contents of which are herein incorporated by reference in its entirety.

### BACKGROUND

1. Field

This invention relates generally to selfcare products and, more particularly, to a basket that is removably attachable to a walker.

2. Background

The elderly or handicapped often use a walker device to assist in overcoming mobility difficulties. A walker typically comprises a unshaped frame that includes downwardly-extending legs on which the user applies at least a portion of his or her weight. Although the walker can provide increased mobility, the user must typically use both hands on the walker, which makes it difficult or impossible to carry additional items while using the walker.

One solution to this problem is to equip the walker with a container device, such as a basket, in which items can be inserted. The container is then attached to the walker so that the user can transport items in the container while using the walker. One problem with such containers is that they can consume a large amount of space. Indeed, it is generally desirable to make the container as large as possible so that it can store and transport a larger amount of items. However, this can make it difficult to store or transport the walker/container combination in small spaces. In view of the foregoing, there is a need for a walker and basket that can store a large number of items but does not consume a large amount of space when not in use.

### SUMMARY

Embodiments disclosed herein address the above stated need for a walker basket that can store a large number of items but does not consume a large amount of space when not in use. In one embodiment a basket is configured to be removably coupled to a walking aid, also referred to as a walker. The basket includes a frame having a first and a second side and a first and a second scissor hinge. The scissor hinges are attached at opposed ends of the frame sides and operate such that the frame sides can be positioned next to each other in a collapsed state and separated from each other in an expanded state. In the expanded state the frame sides and scissor hinges form an internal cavity. A flexible material, such as canvas, is attached to the frame sides and scissor hinges thereby forming side walls and a bottom of the internal cavity when the frame is in the expanded state such that items can be placed in and removed. The flexible material can fold thereby allowing the frame to be collapsed so that the frame sides are positioned next to each other. The basket in the collapsed state occupies significant less space that when in the expanded state. The basket also include a coupling member, such as a hook, that can be removably mounted to the walking aid.

In one embodiment the first and second frame sides each form a rectangular shape made up of a plurality of struts. In addition, the first and second scissor hinges are made up of a pair of elongated struts arranged in a cross-relationship such that the struts can rotate with respect to one another. In one embodiment the scissor hinges are slidably attached to the side frames struts by clips. The clips can include an annular region defining an opening into which a strut of the side frame is positioned. The clips may be elastically yieldable such one or more detents on the strut engage the clips to retain the clips in a predetermined orientation, for example in the expanded state or the collapsed state. Application of sufficient force can cause the clips to elastically yield thereby engaging or disengaging the detent to allow the basket to be expanded or collapsed.

In another embodiment, the basket also includes at least one lower support member that is movably mounted to the frame. The support member can be extended so that at least a portion of the support member can be removably coupled to the walking aid. The support member can also be moved to a storage position with the support member being nestled closer to the frame so as to reduce the size of the frame in the collapsed state.

In yet another embodiment the basket includes a retaining structure, such as a flexible strap, positioned on an internal surface of a frame side for retaining items inside the basket.

Other features and advantages of the present invention should be apparent from the following description of exemplary embodiments, which illustrate, by way of example, aspects of the invention.

### BRIEF DESCRIPTION OF THE DRAWINGS

FIG. 1 shows a perspective view of a walker and a walker basket of the present invention.

FIG. 2 shows a perspective view of the walker basket in an expanded state.

FIG. 3 shows a perspective view of the walker basket in a collapsed state.

FIG. 4 shows a perspective view of a clip of the walker basket.

### DETAILED DESCRIPTION

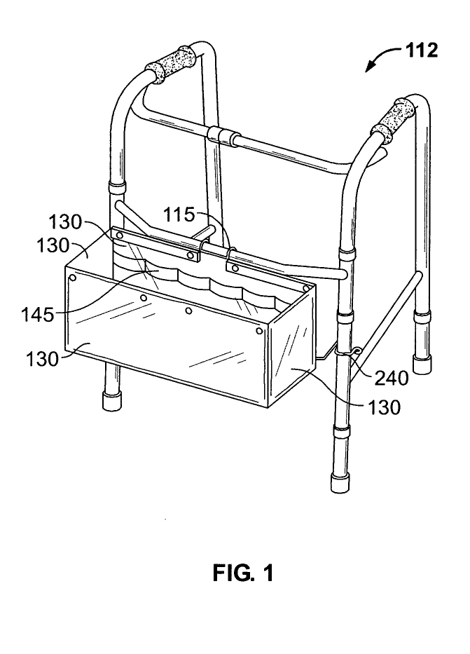

Disclosed is a basket that is configured to be removably coupled to a walking aid commonly referred to as a walker. As shown in FIG. 1, the basket 110 is positioned on a walker 112. The basket 110 defines an internal cavity in which one or more items can be removably located. The basket includes a coupling member, such as a hook 115, that can be removably coupled to a walker 112 so that the basket 110 can be removably mounted on the walker 112. The basket 110 has a generally rectangular shape and includes four side walls 130 that define the sides of the basket and a bottom wall (not shown) that forms the bottom of the basket. At least some of the walls are formed of a flexible material, such as a canvas, that can fold when the basket 110 transitions to a collapsed state, as described below. FIG. 1 does not show the basket 110 having a top wall in order to provide access to the internal cavity, although it should be appreciated that the basket can be equipped with a top wall.

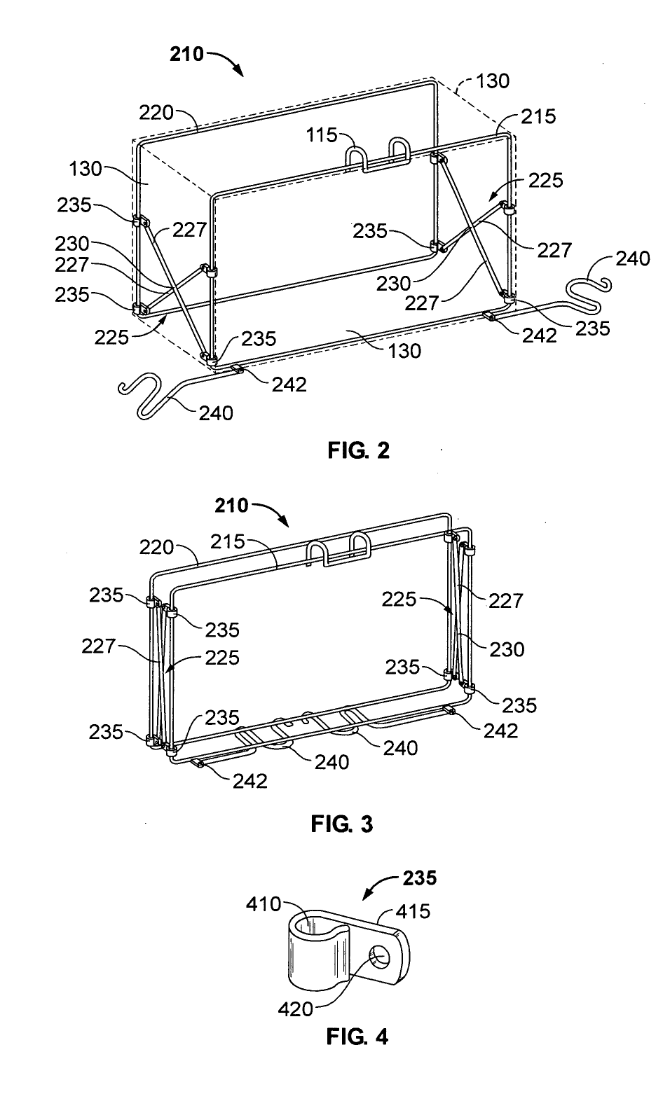

The basket 110 can transition between an expanded state and a collapsed state. FIG. 2 shows a perspective view of an internal frame 210 of the basket 110 in an expanded state and FIG. 3 shows the internal frame 210 in the collapsed state. For ease of illustration, the side walls 130 and bottom wall 132 are shown in FIG. 2 using phantom lines. With reference to FIG. 2, the internal frame 210 comprises a plurality of struts that are collectively arranged to form a rectangular shape. In this regard, the struts form a first side frame 215 and a second side frame 220 that both are rectangular in shape. The side frames 215 and 220 provide the internal structure for the opposed side walls of the walker basket 110.

A pair of scissor hinges 225 connect the side frames 215, 220 to one another. Each scissor hinge 225 comprises a pair of elongated struts 227 that are arranged in a cross-relationship such that the struts 227 can rotate with respect to one another at a location 230. A clip 235 is located at each of the ends of the struts 227. As described below, each clip 235 is configured to slidably attach to a portion of the side frames 215, such as to a vertical strut of the side frame. When attached in the correct manner, the scissor hinges 225 are located at opposed ends of the side frames 215, 220 to provide the entire internal frame 215 with a rectangular shape.

With reference still to FIG. 2, the hook 115 is located at an upper region of the side frame 215. The hook 115 can have any shape that permits it to be removably coupled to the walker 112. For example, in the illustrated embodiment, the hook 115 is comprised of a wire or rod that forms a curved loop that can be hooked onto a horizontal bar on the walker. It should be appreciated, however, that other structures can be used.

The internal frame 210 also includes one or more lower support members 240 that are movably mounted to the frame 210, such as using a hinge 242. The support members 240 are attached to the frame 210 such that they can be moved to an extended position in which the support members 240 extend outwardly from the frame 210. In the extended position, the support members 240 are oriented such that at least a portion of the support members 240 can be removably coupled to the walker 112 when the basket 110 is mounted on the walker 112. This is shown in FIG. 1, where the support members 240 are shown in the extended position and hooked onto vertically-oriented legs of the walker 112. It should be appreciated that the support members 240 can be sized and shaped so as to attach to any of a variety of locations on the walker 112. As described below, the support members 240 can be moved from the extended position to a storage position wherein the support members 240 are nestled closer to the internal frame 210 so as to reduce the size of the internal frame 210 during storage.

FIG. 3 shows a perspective view of the internal frame in the collapsed state. When in the collapsed state, the internal frame and the basket consume less space then in the expanded state. The side frames 215 and 220 have been moved toward one another so that the internal frame 210 is flattened with respect to the expanded state. The internal frame 210 is moved into the collapsed state by pushing the side frames 215 toward one another such that the scissor hinge cross struts 227 rotate with respect to one another about the rotation location 230. As the struts 227 rotate, the upper clips 235 on the ends of the struts 227 slide upward along the vertical side struts of the side frames 215 and 220.

Once the side frames 215 and 220 have been collapsed toward one another, the entire internal frame 210 has a reduced size with respect to size of the internal frame in the expanded state. The support members 240 are then rotated into the storage position, as shown in FIG. 3. When in the storage position, the support members 240 no longer protrude outward from the internal frame 210, but are rather nestled beneath the side frames 215 and 220. In this manner, the support members 240 advantageously do not increase the size of the internal frame 210 during storage.

FIG. 4 is a perspective view of one of the clips 235 that attach the scissor hinges to the side frames 215, 220. The clip 235 has an annular region 410 that defines an opening into which vertical struts of the side frames can be positioned. The clip 235 also includes an attachment member, such as a tab 415 with an aperture 420. An attachment device, such as a screw or bolt, can be mated with a strut 227 of the scissor hinge to attach the clip to the scissor hinge.

The clip 235 and the vertical struts 227 of the side frames 215, 220 are manufactured of a material that can slightly yield in an elastic manner. In this regard, the struts 227 can be equipped with one or more detents, such as protrusions, that can engage the clips to retain the clips (and the scissor hinges) in a predetermined orientation, such as in the collapsed state or in the expanded state. A sufficient force can be applied to the clip 235 such that the annular region of the clip and/or the protrusion slightly yields and allow the clip to be slid over the protrusion. In this manner, the scissor hinges can be moved between the collapsed state and the expanded state.

As mentioned, the internal frame 210 is covered with a material that forms peripheral walls of the internal frame. The walls provide support surfaces for supporting one or more items that are positioned within the internal cavity. As shown in FIG. 1, at least one retaining structure 145 is positioned on the internal surface of the wall for retaining an item inside the internal cavity. In one embodiment, the retaining structure comprises a flexible strap that can be stretched outwardly to receive an item between the strap and the wall to which it is attached. The strap is biased toward the wall so that it secures the item in between the strap and the wall. The strap can be manufactured of a flexible, elastic material.

Although embodiments of various methods and devices are described herein in detail with reference to certain versions, it should be appreciated that other versions, embodiments, methods of use, and combinations thereof are also possible. Therefore the spirit and scope of the appended claims should not be limited to the description of the embodiments contained herein.

1. A basket configured to be removably coupled to a walking aid, the basket comprising:
a frame comprising a first and a second frame side and a first and a second scissor hinge, wherein the scissor hinges are attached at opposed ends of the frame sides thereby forming frame ends, the scissor hinges operating such that the frame sides can be position next to each other in a collapsed state, and separated from each other in an expanded state thereby providing an internal cavity;
a flexible material attached to the frame sides and ends thereby forming side and end walls and a bottom of the internal cavity when the frame is in the expanded state, wherein the flexible material allows the frame sides to be positioned next to each other in the collapsed state; and
a coupling member that can be removably mounted to the walking aid.

2. A basket as defined in claim 1, wherein the first and second frame sides each form a rectangular shape comprised of a plurality of struts.

3. A basket as defined in claim 1, wherein the first and second scissor hinges each comprise a pair of elongated struts arranged in a cross-relationship such that the struts can rotate with respect to one another.

4. A basket as defined in claim 1, wherein the coupling member comprises a hook.

5. A basket as defined in claim 1, wherein the flexible material comprises canvas.

6. A basket as defined in claim 1, further comprising at least one support member movably mounted to the frame.

7. A basket as defined in claim 6, wherein the support member can be extended so that at least a portion of the support member can be removably coupled to the walking aid.

8. A basket as defined in claim 6, wherein the support member can be moved to a storage position such that the support member is nestled near to the frame so as to reduce the size of the frame with the support member in the collapsed state.

9. A basket as defined in claim 6, wherein the support member is attached to a lower surface of a frame side.

10. A basket as defined in claim 1, wherein the scissor hinges are slidably attached to the side frames by clips that comprises an annular region defining an opening into which a strut of the side frame is positioned.

11. A basket as defined in claim 10, wherein the clip is elastically yieldable such that one or more detents on the strut engage the clips thereby retaining the clips in a predetermined orientation.

12. A basket as defined in claim 11, wherein that application of sufficient force causes the clip to elastically yield thereby engaging or disengaging the detent.

13. A basket as defined in claim 11, wherein the predetermined orientation corresponds to the expanded state of the frame.

14. A basket as defined in claim 11, wherein the predetermined orientation corresponds to the collapsed state of the frame.

15. A basket as defined in claim 1, further comprises a retaining structure positioned on an internal surface of a frame wall for retaining items inside the internal cavity.

16. A basket as defined in claim 15, wherein the retaining structure is a flexible strap.

17. A basket configured to be removably coupled to a walker, the basket comprising:
a frame comprising a first and a second frame side, each frame side forming a rectangular shape comprised of a plurality of struts;
a first and a second scissor hinge comprised of a pair of elongated struts arranged in a cross-relationship such that the struts can rotate with respect to one another, wherein the scissor hinges are slidably attached at opposed ends of the frames sides thereby forming frame ends, the scissor hinges operating such that the frame sides can be position next to each other in a collapsed state, and separated from each other in an expanded state thereby providing an internal cavity;
a flexible material attached to the frame sides and ends forming side and end walls and a bottom of the internal cavity when the frame is the expanded state, wherein the flexible material allows the frame sides to be positioned next to each other in the collapsed state; and
a coupling member that can be removably mounted to the walker.

18. A basket as defined in claim 17, wherein the scissor hinges are slidably attached to the side frames by clips, wherein the clips comprises an annular region defining an opening into which a strut of the side frame is positioned, the clip being elastically yieldable such that one or more detents on the strut engage the clips thereby retaining the clips in a predetermined orientation corresponding to an expanded state or a collapsed state.

19. A basket as defined in claim 18, wherein that application of sufficient force causes the clip to elastically yield thereby engaging or disengaging the detent.

20. A basket configured to be removably coupled to a walking aid, the basket comprising:
means for forming a frame comprising a first and a second frame side;
means for attaching the frame sides, thereby forming frame ends, such that the frame sides can be position next to each other in a collapsed state, and separated from each other in an expanded state thereby providing an internal cavity;
means for forming side, end and bottom surfaces of the internal cavity when the frame is in the expanded state and allowing the frame sides to be positioned next to each other in the collapsed state; and
means for coupling the frame to the walking aid.
